(19) United States
(12) Patent Application Publication
(10) Pub. No.: US 2007/0131902 A1
(43) Pub. Date: Jun. 14, 2007

(54) Polymer dispersed liquid crystal emulsion and polymer dispersed liquid crystal composite film

(75) Inventors: Ching-Kuan Lee, Yunlin County (TW); Ching-Yu Chen, Hsinchu City (TW); Yang Chu Lin, Hsinchu (TW); Kung Lung Cheng, Hsinchu (TW); Yu-Nan Tzeng, Tainan City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/335,559

(22) Filed: Jan. 20, 2006

(30) Foreign Application Priority Data
Dec. 9, 2005 (TW) 94143577

(51) Int. Cl. C09K 19/52; C09K 19/38; C09K 19/54

(52) U.S. Cl. 252/299.01; 252/299.5; 428/1.3

(57) ABSTRACT

The invention discloses a material capable of adjusting light, such as a polymer dispersed liquid crystal emulsion, comprising a liquid crystal, a polymer and a halogen contained non-ionic surfactant. The invention also discloses a polymer dispersed liquid crystal composite film comprising the polymer dispersed liquid crystal emulsion sandwiched between a pair of plates. The driving voltage of the material capable of adjusting light is reduced by means of adding the additives to the liquid crystal.

### BACKGROUND OF THE INVENTION

1. Field of the Invention

The present invention relates to polymer dispersed liquid crystal ( PDLC) emulsion and fabricating methods thereof, and in particular relates to a PDLC composite film with low driving voltage and fabrication methods thereof.

2. Description of the Related Art

Micro-size liquid crystal droplets dispersed in a polymer constitutes are referred to as PDLC. A composite film made of the PDLC stays nontransparent as no outside electric field is applied while it becomes transparent as an outside electric field exists. Conventional fabrication methods of PDLC composite film comprise emulsion, phase separation or encapsulation.

As to emulsion, the liquid crystal is emulsified and dispersed in a polymer solution, then applied to an electrically conductive substrate such as a PET substrate or a glass substrate with an ITO film thereon. After the solvent removed by heating, a composite film is formed and the liquid crystal droplet is dispersed in the polymer.

Phase separation primarily comprises thermally-induced phase separation (TIPS), solvent-induced phase separation (SIPS) and polymerization-induced phase separation (PIPS). As to TIPS, the liquid crystal and the polymer are mixed at high temperature, then applied to an electrically conductive substrate and then cooled, thus, the polymer returns to solid state and the liquid crystal is deposited and dispersed in the polymer. As to SIPS, the liquid crystal and the polymer are poured into an organic solvent to form a homogeneous phase, then applied to a substrate and then baked to remove the solvent, thus, the liquid crystal is deposited and dispersed in the polymer. As to PIPS, the liquid crystal and the oligomer (or the monomers with low molecular weight) are well mixed, then heated or conducted to radiation, thus a PDLC composite film is formed due to deposition of the liquid crystal from the polymer.

As to encapsulation, the liquid crystal and the reactive monomer are mixed evenly, then dissolved in an aqueous polymer (such as PVA) solution including surfactants, thus, liquid crystal/reactive monomer droplets of 1˜10 μ are formed. Thereafter, a binder agent is added, and then heated to have the reactive monomer form a cross-linked polymer. In the intervening time, the liquid crystal is trapped in the polymer to form encapsulations. Encapsulations of similar size are selected by a centrifuge, then dispersed in an aqueous polymer solution and then applied to a substrate. Finally, a PDLC composite film is obtained after the solvent is removed.

Properties of the PDLC composite film can be affected by following parameters: the thickness of the film; the dimension or size or size distribution of the liquid crystal, kinds of liquid crystals; molecular weight or kinds of the polymer; the degree of polymerization or crosslinking of the polymer; solubility of the liquid crystal in the polymer; reflectivity of the liquid crystal or the polymer; content of the liquid crystal or the polymer; or content of additives (such as surfactants) or metal ions.

PDLC composite film, without being coupled to a polarizer or an aligner film, can be directly utilized in large-size FPD, banners and smart windows for buildings or cars. Various PDLC composite films with different functions can be obtained by means of selection of the liquid crystal or the dichroic dye and adjustment of the liquid crystal size. Additionally, PDLC composite films are employed in fabrication of PDLC devices capable of adjusting wave lengths of light. However, conventional PDLC devices operates at a high driving voltage (about 40˜60 V), thus, the liquid crystal of a high resistance is required to maintain charge retentivity (or charge retention). Accordingly, reducing driving voltage can improve charge retaintivity and save power.

Due to problems such as low contrast ratio and high driving voltage etc. in the conventional PDLC device, a material capable of adjusting light which can operates at a low driving voltage is desirable.

### BRIEF SUMMARY OF THE INVENTION

In view of the described problems of the related art, reduction of the driving voltage is accomplished by adding additives to the polymer dispersed liquid crystal in accordance with the invention. The driving voltage is lowered due to a weakened force between the polymer and the liquid. That is, additives are arranged between the polymer and the liquid crystal by means of forces among molecules, the force between the polymer and one end of the additives is stronger than that between the liquid crystal and the other end of the additives, hence, the force between the polymer and the liquid crystal is weakened.

One embodiment of the invention discloses a material capable of adjusting light, such as a PDLC emulsion, comprising a liquid, a polymer and a halogen-containing non-ionic surfactant. In other embodiments, the halogen-containing non-ionic surfactant comprises a fluoride-containing non-ionic surfactant. In other embodiments, the concentration of the halogen-containing non-ionic surfactant in the PDLC emulsion is substantially between 0.01˜5%. In other embodiments, the polymer is selected from a group of polyvinyl alcohol, polyvinyl alcohol copolymer, poly(ethylene oxide), polymethyl vinyl ether/maleic anhydride, poly(vinyl pyrrolidone), cellulosic polymer, natural gums, polyurethane, epoxy resin, photosensitive acryl resin, and polyacrylate.

In addition, another embodiment of the invention discloses a PDLC composite film, comprising the PDLC emulsion and a pair of substrates sandwiched between the PDLC emulsion and the substrates.

The driving voltage of the material capable of adjusting light is reduced by means of adding additives to the liquid crystal. Accordingly, the material of the invention can be widely applied in watch displays, automatic displays, tags, advertising displays, or smart windows for buildings or cars.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows fabrication methods of a PDLC emulsion, a PDLC composite film and a PDLC device in accordance with the invention; and

FIG. 2 shows the comparison between the first and second embodiment in driving voltage.

FIG. 3 shows an enlarged view of a liquid crystal droplet 40.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Hereinafter, the symbol “%” refers to “weight percentage”. The following embodiments employ emulsion as fabrication methods of a PDLC emulsion. As described, the liquid crystal is emulsified and dispersed in a polymer solution, then applied to a electrically conductive substrate such as a PET substrate or a glass substrate with an ITO film thereon. After the solvent removed by heating, a composite film is formed and the liquid crystal droplet is deposited and dispersed in the polymer.

### FIRST EMBODIMENT

2 grams of UCL032 (liquid crystal mixtures manufactured by ITRI, in Taiwan) or E-7™ (manufactured by Merck Co.) with 0.01˜10% additives mixtures (such as alcohols with low boiling point, e.g. methyl alcohol and ethyl alcohol) are blended. UCL032 comprises 4′-alkyl-bicyclhexylic acid 4-fluoro-phenyl ester, 4-(4-alkylcyclohexylbenzoic acid 4-cyano-3-fluoro-phenyl ester, 4-(4-alkyl-cyclohexyl)-benzoic acid 4-alkylphenyl ester and 4-methylcyclohexanecarboxylic acid 4′-cyano-biphenyl-4-yl ester.

5 grams of a solution containing 20% (manufactured by Chang Chun Chemical Co., Ltd) is added to the described mixtures, i.e. UCL032/ E-7™ and additives. The resultant mixtures are stirred by a homogenizer for 3 to 5 minutes, thus, a liquid crystal emulsion, i.e. liquid crystal droplets dispersed in the PVA solution, is obtained.

The liquid crystal emulsion is applied to an ITO film containing PET or a glass substrate by means of a coater with a square frame. The diameter of the dispenser can be set at 50, 75 or 100 micrometers. Thereafter, the PET or glass substrate with the liquid crystal emulsion thereon is placed in an oven at 100° C. for 5 minutes, thus, the solvent contained in the liquid crystal emulsion is removed. Accordingly, a PDLC composite film is obtained.

An adhesive is applied to the perimeter of a bare ITO-PET or ITO-glass substrate. Finally, a device capable of adjusting light is formed by attachment of the bare ITO-PET or ITO-glass substrate to the ITO-PET or ITO-glass substrate with a PDLC composite film thereon. The adhesive can be a photosensitive acrylic adhesive, e.g. NOA65 or NOA72, or a pressure sensitive adhesive, e.g. PVA or PVB.

### SECOND EMBODIMENT

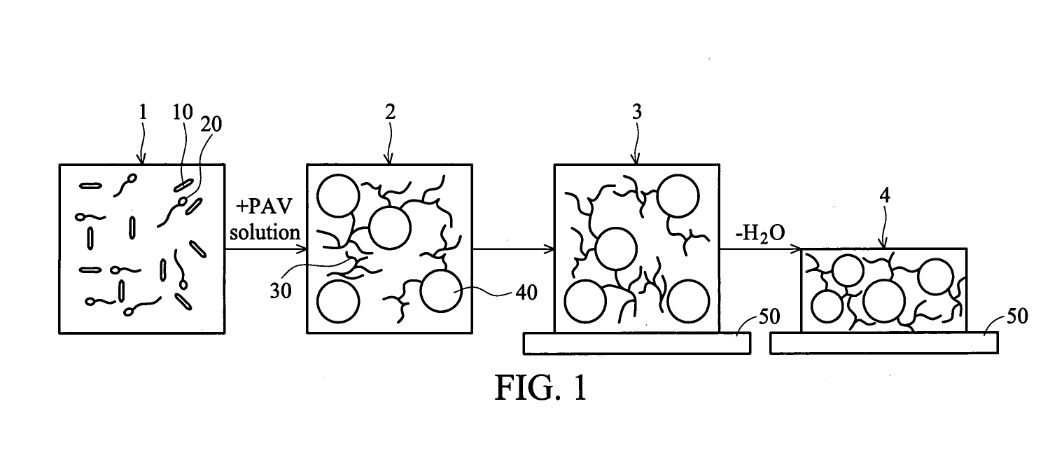

As shown in step 1 of FIG. 1, 2 grams of UCL032 (liquid crystal mixtures manufactured by ITRI, in Taiwan) or E-7™ (manufactured by Merck Co.) with 0.01˜5% fluoride-containing non-ionic surfactant such as ZONYL FSN, ZONYL FSO (both are manufactured by DuPond), FC 4430 (manufactured by 3M), FC 4432 (manufactured by 3M), BYK340 (manufactured by BKY-Chemie GmbH), or BYK344 (manufactured by BKY-Chemie GmbH) are blended. Fluoride-containing non-ionic surfactant or other halogen-containing non-ionic surfactant can be used in other embodiments.

As shown in step 2 of FIG. 1, 5 grams of a solution containing 20% (manufactured by Chang Chun Chemical Co., Ltd) is added to the described mixtures, i.e. UCL032/E-7™ and additives. The resulting mixtures are stirred by a homogenizer for 3 to 5 minutes, thus, a liquid crystal emulsion, i.e. liquid crystal droplets dispersed in the PVA solution, is obtained.

As shown in step 3 of FIG. 1, the liquid crystal emulsion is applied to an ITO film containing PET or glass substrate 50 by means of a coater with a square frame. The diameter of the dispenser can be set at 50, 75 or 100 micrometers. Thereafter, the PET or glass substrate with the liquid crystal emulsion thereon is placed in an oven at 100° C. for 5 minutes, thus, the solvent contained in the liquid crystal emulsion is removed. Accordingly, a PDLC composite film is obtained.

As shown in step 4 of n FIG. 1, an adhesive is applied to the perimeter of a bare ITO-PET or ITO-glass substrate. Finally, a device capable of adjusting light is formed by attachment of the bare ITO-PET or ITO-glass substrate to the ITO-PET or ITO-glass substrate 50 with a PDLC composite film thereon. The adhesive can be a photosensitive acrylic adhesive, e.g. NOA65 or NOA72, or a pressure sensitive adhesive, e.g. PVA or PVB.

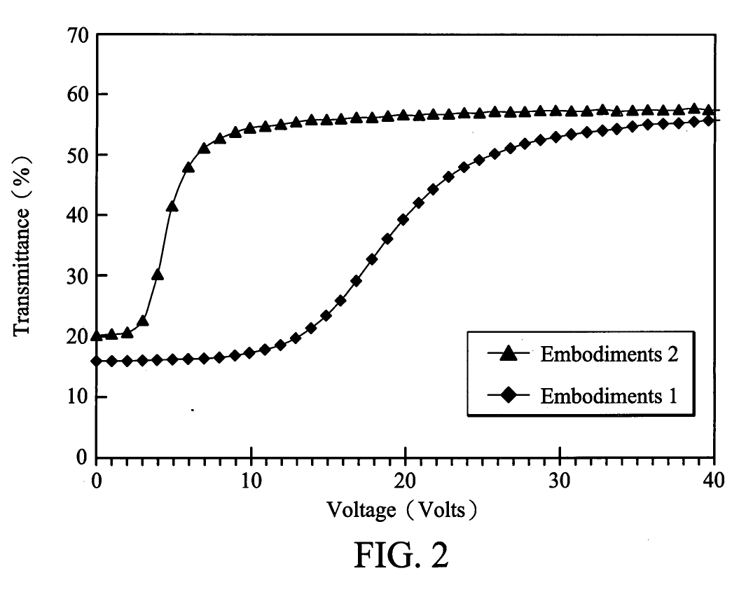

FIG. 2 shows the comparison between the first and second embodiments in driving voltage. The Y-axis represents “light transmittance” and the X-axis represents “driving voltage”. As shown in FIG. 2, the second embodiment only requires a driving voltage of less than 10 V apparently less than 40V of the first embodiment to achieve a same light transmittance (about 50%)

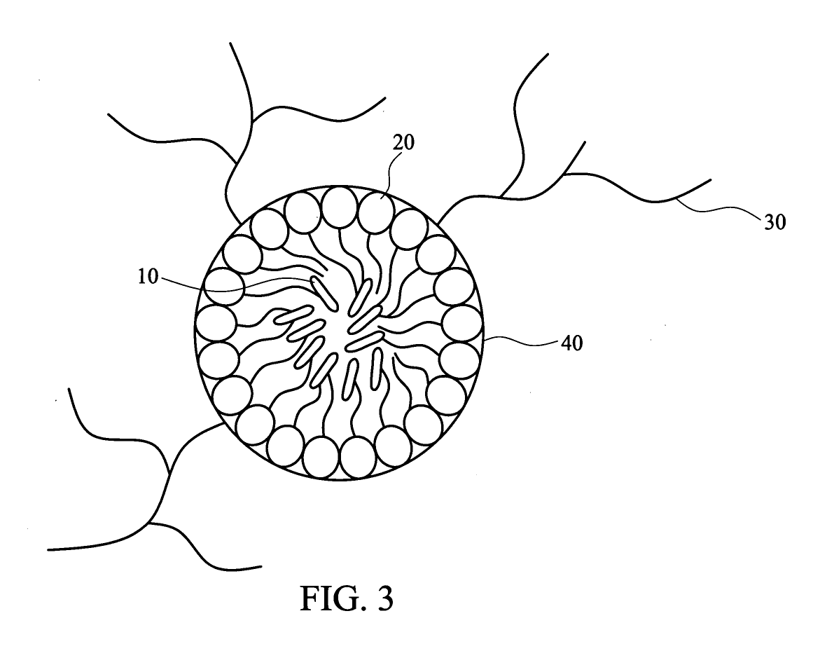

As described, by means of properly adding the fluoride-containing non-ionic surfactant to the PDLC, the driving voltage of the PDLC can be lowered. As shown in FIG. 3, the driving voltage is lowered due to a weakened force between the polymer and the liquid. That is, the fluoride-containing non-ionic surfactant 20 is arranged between the polymer 30 and the liquid crystal 10 by means of the force among molecules, the force between the polymer 30 and one end of the fluoride-containing non-ionic surfactant 20 is strong than that between the liquid crystal 10 and the other end of the fluoride-containing non-ionic surfactant 20, hence, the force between the polymer 30 and the liquid crystal 10 is weakened.

Accordingly, the material of the invention can be widely applied in watch displays, automatic displays, tags, advertising displays, or smart windows for buildings or cars.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A PDLC emulsion, comprising:
a liquid;
a polymer; and
a halogen-containing non-ionic surfactant.

2. The PDLC emulsion as claimed in claim 1, wherein the halogen-containing non-ionic surfactant comprises a fluoride-containing non-ionic surfactant.

3. The PDLC emulsion as claimed in claim 1, wherein the concentration of the halogen-containing non-ionic surfactant in the PDLC emulsion is substantially between 0.01˜5%.

4. The PDLC emulsion as claimed in claim 1, wherein the polymer is selected from a group of polyvinyl alcohol, polyvinyl alcohol copolymer, poly(ethylene oxide), polymethyl vinyl ether/maleic anhydride, poly(vinyl pyrrolidone), cellulosic polymer, natural gums, polyurethane, epoxy resin, photosensitive acryl resin, and polyacrylate.

5. The PDLC emulsion as claimed in claim 1, wherein the concentration of the liquid crystal in the PDLC emulsion is substantially between 1˜90%.

6. The PDLC emulsion as claimed in claim 1, wherein the concentration of the polymer in the PDLC emulsion is substantially between 1˜50%.

7. A PDLC composite film, comprising:
the PDLC emulsion as claimed in claim 1; and
a pair of substrates sandwiched between the PDLC emulsion and the substrates.

8. The PDLC composite film as claimed in claim 7, wherein the halogen-containing non-ionic surfactant comprises a fluoride-containing non-ionic surfactant.

9. The PDLC composite film as claimed in claim 7, wherein the concentration of the halogen-containing non-ionic surfactant in the PDLC emulsion is substantially between 0.01˜5%.

10. The PDLC composite film as claimed in claim 7, wherein the polymer is selected from a group of polyvinyl alcohol, polyvinyl alcohol copolymer, poly(ethylene oxide), polymethyl vinyl ether/maleic anhydride, poly(vinyl pyrrolidone), cellulosic polymer, natural gums, polyurethane, epoxy resin, photosensitive acryl resin, and polyacrylate.

11. The PDLC composite film as claimed in claim 7, wherein the concentration of the liquid crystal in the PDLC emulsion is substantially between 1˜90%.

12. The PDLC composite film as claimed in claim 7, wherein the concentration of the polymer in the PDLC emulsion is substantially between 1˜50%.

13. The PDLC composite film as claimed in claim 7, wherein the substrate comprises a flexible substrate or a glass substrate.

14. The PDLC composite film as claimed in claim 13, the flexible substrate comprises a PET substrate, a PEN substrate or a PES substrate.

15. The PDLC composite film as claimed in claim 7, further comprising a transparent conductive film disposed between the substrate and the PDLC emulsion.

16. The PDLC composite film as claimed in claim 15, wherein the transparent conductive film comprises an ITO film.
